(19) United States
(12) Patent Application Publication
(10) Pub. No.: US 2023/0386273 A1
(43) Pub. Date: Nov. 30, 2023

(54) PREDICTIVE VEHICLE TROUBLESHOOTING METHODS AND SYSTEMS

(71) Applicant: GM GLOBAL TECHNOLOGY OPERATIONS LLC, Detroit, MI (US)

(72) Inventors: Sridhar Kamma, Austin, TX (US); Gregory Morrow, Austin, TX (US); Thomas Sandrisser, Austin, TX (US)

(73) Assignee: GM GLOBAL TECHNOLOGY OPERATIONS LLC, Detroit, MI (US)

(21) Appl. No.: 17/664,764

(22) Filed: May 24, 2022

(51) Int. Cl. G07C 5/08; G07C 5/10

(52) U.S. Cl. CPC G07C 5/0825; G07C 5/0808; G07C 5/10

(57) ABSTRACT

Vehicle diagnostic methods and systems are provided for providing predictive step-by-step troubleshooting guidance. One method involves determining a sequence of recommended troubleshooting actions for resolving a potential fault condition associated with a diagnostic code based at least in part on a vehicle component associated with the diagnostic code and metadata associated with the vehicle using historical diagnostics data and sequentially providing, within a client application at a client device, graphical indicia of the recommended troubleshooting actions in accordance with the sequence based on a respective probability of resolution associated with the respective recommended troubleshooting actions based at least in part on the historical diagnostics data.

### INTRODUCTION

The technical field generally relates to vehicle systems and more particularly relates to diagnostics and troubleshooting during manufacturing.

Modern vehicles include numerous different electrical circuits or electronic modules. Vehicle electrical systems have become complex, often with electrical wiring harnesses having hundreds of connectors, pins, wires, cables, locks, shells and the like to be connected to any number of different electronic modules or electrical components. This, in turn, results in an increasing number of issues that can arise during assembly and increases the complexity of manually diagnosing potential problems. For example, an assembler may overlook or fail to establish a particular connection, connector pins might break during assembly, wires or cables might be pinched or broken, or an electronic module or electrical component could itself be defective. However, validation of the electrical wiring harnesses and related electrical systems does not occur until towards the back end of the manufacturing line after battery and software installation, at which point it is difficult and disruptive to stop the manufacturing line to attempt to address the problem. Accordingly, it is desirable to provide vehicle diagnostic systems and methods that facilitate resolution of electrical problems to reduce mean time to repair (MTTR) and improve run rate. Other desirable features and characteristics of the present invention will become apparent from the subsequent detailed description and the appended claims, taken in conjunction with the accompanying drawings and the foregoing technical field and background.

### SUMMARY

Vehicle diagnostic methods and systems are provided for providing predictive step-by-step troubleshooting guidance. In one implementation, an apparatus is provided for a non-transitory computer-readable medium having executable instructions stored thereon that, when executed by a processor, cause the processor to obtain metadata associated with a vehicle, obtain a diagnostic code associated with the vehicle, identify a vehicle component associated with the diagnostic code based at least in part on the metadata, determine a recommended troubleshooting action for resolving a potential fault condition associated with the diagnostic code based at least in part on the vehicle component and the metadata associated with the vehicle using historical diagnostics data, and provide, within a client application at a client device, a graphical indication of the recommended troubleshooting action.

In one aspect, the executable instructions cause the processor to provide, within the client application at the client application, an image associated with the recommended troubleshooting action, wherein the graphical indication of the recommended troubleshooting action and the image are displayed concurrently on a graphical user interface (GUI) display within the client application at the client device. In one implementation, the vehicle component includes an electrical circuit and the image includes a graphical representation of a circuit diagram associated with the electrical circuit. In another implementation, the image includes a three-dimensional graphical representation of the vehicle component.

In another aspect, the executable instructions cause the processor to provide, within the client application at the client device, a GUI display including the graphical indication of the recommended troubleshooting action and a GUI element to receive indication of an outcome of the recommended troubleshooting action. In one implementation, the executable instructions cause the processor to dynamically update the GUI display to include a second graphical indication of a second recommended troubleshooting action in response to selection of the GUI element to indicate the outcome of the recommended troubleshooting action was unsuccessful. In a further implementation, the executable instructions cause the processor to identify the second recommended troubleshooting action as one of a plurality of potential troubleshooting actions having a next highest probability of resolving the potential fault condition after the recommended troubleshooting action based on the prediction model.

In another aspect, the executable instructions cause the processor to determine the recommended troubleshooting action by identifying one of a plurality of potential troubleshooting actions having a highest probability of resolving the potential fault condition using a prediction model derived from the historical diagnostics data. In one implementation, the prediction model is derived from the historical diagnostics data using bidirectional encoder representations from transformers (BERT) and the executable instructions cause the processor to identify the one of the plurality of potential troubleshooting actions having the highest probability of resolving the potential fault condition using the prediction model and natural language processing (NLP) of at least one of the metadata associated with the vehicle, the diagnostic code associated with the vehicle, and the vehicle component associated with the diagnostic code.

In another aspect, the executable instructions cause the processor to provide one or more GUI displays within the client application at the client device, wherein the one or more GUI displays include one or more GUI elements for receiving user input including at least one of the metadata and the diagnostic code. In yet another aspect, the executable instructions cause the processor to identify the diagnostic code associated with the metadata associated with the vehicle using the metadata associated with the vehicle in response to receiving user input including the metadata.

In another implementation, a method of facilitating diagnostics of a vehicle is provided. The method involves obtaining metadata associated with the vehicle, identifying a diagnostic code associated with the vehicle using the metadata associated with the vehicle, identifying a vehicle component associated with the diagnostic code based at least in part on the metadata, determining a sequence of recommended troubleshooting actions for resolving a potential fault condition associated with the diagnostic code based at least in part on the vehicle component and the metadata associated with the vehicle using historical diagnostics data, and sequentially providing, within a client application at a client device, graphical indicia of the recommended troubleshooting actions in accordance with the sequence based on a respective probability of resolution associated with a respective recommended troubleshooting action based at least in part on the historical diagnostics data. In one aspect, the method involves providing, within the client application at the client device, one or more images associated with one or more of the recommended troubleshooting actions. In a further aspect, providing the one or more images involves providing a graphical representation of a circuit diagram associated with the vehicle component on a GUI display within the client application at the client device concurrent to providing a graphical indication of a recommended troubleshooting action of the one or more of the recommended troubleshooting actions on the GUI display. In another implementation, providing the one or more images involves providing a three-dimensional graphical representation of the vehicle component on a GUI display within the client application at the client device concurrent to providing a graphical indication of a recommended troubleshooting action of the one or more of the recommended troubleshooting actions on the GUI display. In another aspect, sequentially providing the graphical indicia of the recommended troubleshooting actions involves providing, on a GUI display within a client application at a client device, a graphical indication of an initial recommended troubleshooting action of the sequence having a highest probability of resolution associated therewith based at least in part on the historical diagnostics data, and in response to user selection of a GUI element on the GUI display to indicate the initial recommended troubleshooting action was unsuccessful, dynamically updating the GUI display to provide a second graphical indication of a second recommended troubleshooting action of the sequence having a second highest probability of resolution associated therewith based at least in part on the historical diagnostics data. In one implementation, the method involves providing, on the GUI display, a first image associated with the initial recommended troubleshooting action and dynamically updating the GUI display to provide a second image associated with the second recommended troubleshooting action in lieu of the first image in response to the user selection of the GUI element.

In another implementation, a system is provided that includes a data storage element to maintain a log of diagnostics data and a server coupled to the data storage element and a network, the server including at least one processor and at least one non-transitory computer-readable medium including executable instructions that, when executed by the at least one processor, cause the at least one processor to provide a repair assistance application configurable to obtain, from a client device coupled to the network, metadata associated with a vehicle, obtain, from the log of diagnostics data, a diagnostic code associated with the vehicle using the metadata, identify a vehicle component associated with the diagnostic code based at least in part on the metadata, determine a recommended troubleshooting action for resolving a potential fault condition associated with the diagnostic code based at least in part on the vehicle component and the metadata associated with the vehicle using a prediction model derived from at least a portion of the log of diagnostics data, and provide, at the client device, a graphical indication of the recommended troubleshooting action. In one aspect, the data storage element maintains design data associated with the vehicle and the executable instructions cause the at least one processor to provide, within a client application at the client device, an image associated with the recommended troubleshooting action concurrently with providing the graphical indication of the recommended troubleshooting action. In another aspect, the image includes a circuit diagram of the vehicle component or a three-dimensional graphical representation of the vehicle component.

### BRIEF DESCRIPTION OF THE DRAWINGS

The exemplary aspects will hereinafter be described in conjunction with the following drawing figures, wherein like numerals denote like elements, and wherein:

FIG. 1 is a block diagram illustrating a vehicle diagnostics system in accordance with various implementations;

FIG. 2 depicts a flow diagram of a predictive resolution guidance process suitable for implementation by the vehicle diagnostics system of FIG. 1 according to one or more implementations described herein;

FIGS. 3-11 depict a sequence of graphical user interface (GUI) displays that may be generated by a repair assistance web application in the vehicle diagnostics system of FIG. 1 for an example implementation of the predictive resolution guidance process of FIG. 2 according to one or more aspects described herein; and

FIG. 12 depicts an exemplary immersive GUI display that may be generated by a repair assistance web application in the vehicle diagnostics system of FIG. 1 for an example implementation of the predictive resolution guidance process of FIG. 2 according to one or more aspects described herein.

### DETAILED DESCRIPTION

The following detailed description is merely exemplary in nature and is not intended to limit the application and uses. Furthermore, there is no intention to be bound by any expressed or implied theory presented in the preceding introduction, summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

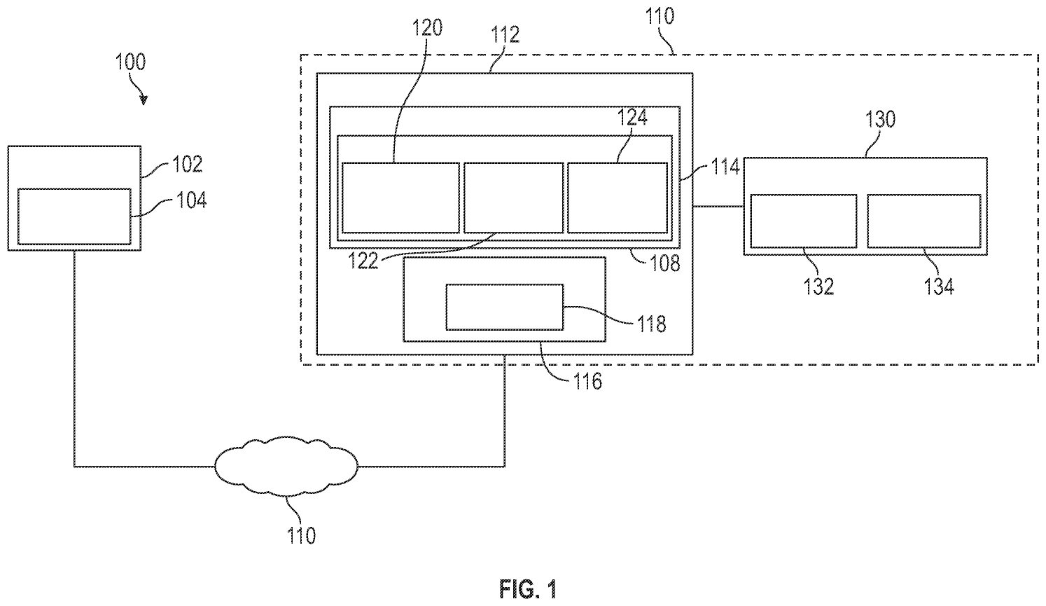

Referring now to FIG. 1, in accordance with one or more embodiments, a vehicle diagnostics system 100 includes a client device 102 that executes or otherwise supports a client application 104 that communicates, over a communications network 106, with an instance of a repair assistance application 108 that is hosted or otherwise supported by a remote system 110. As described in greater detail below, the repair assistance application 108 is configurable to generate or otherwise provide one or more graphical user interface (GUI) displays within the client application 104 at the client device 102 that facilitate a user of the client device 102 resolving a potential fault condition associated with a vehicle, such as, for example, a passenger car, truck, sport utility vehicle (SUV), electric vehicle (EV) or any other sort of vehicle, including, but not limited to motorcycles, recreational vehicles (RVs), marine vessels, aircraft and the like.

The client device 102 generally represents any sort of electronic device that may be communicatively coupled to the communications network 106, which generally represents any one or a combination of different types of suitable communications networks such as, for example, cable networks, wired networks, public networks (e.g., the Internet), private networks, wireless networks, cellular networks, or any other suitable private and/or public networks, including a vehicle-to-infrastructure (V2I), vehicle-to-vehicle (V2V), vehicle-to-pedestrian (V2P), vehicle-to-grid (V2G) communications, or any combinations thereof. Further, the network 106 can have any suitable communication range associated therewith and may include, for example, global networks (e.g., the Internet), metropolitan area networks (MANs), wide area networks (WANs), local area networks (LANs), or personal area networks (PANs). In addition, the network 106 can include any type of medium over which network traffic may be carried including, but not limited to, coaxial cable, twisted-pair wire, optical fiber, a digital medium, an analog medium, a hybrid fiber coaxial (HFC) medium, microwave terrestrial transceivers, radio frequency communication mediums, satellite communication mediums, or any combination thereof.

In practice, the client device 102 can be realized as any sort of personal computer, mobile telephone, tablet, immersive device (e.g., a head-mounted display (HMD) or other augmented reality or virtual reality supporting device) or other network-enabled electronic device, such as, for example, a code reader, scanner or any other sort of automotive diagnostic tool. In exemplary implementations, the client device 102 includes a display device, such as a monitor, screen, or another conventional electronic display, capable of graphically presenting data and/or information along with a user input device, such as a touchscreen, a touch panel, a mouse, a joystick, a directional pad, a motion sensor, or the like, capable of receiving input from the user of the client device 102. The illustrated client device 102 executes or otherwise supports a client application 104 utilized by a user to access an instance of the repair assistance application 108. In some implementations, the client application 104 is realized as a web browser or similar local client application executed by the client device 102 that contacts the repair assistance application 108 at the remote system 110 using a networking protocol, such as the hypertext transport protocol (HTTP), for example, by inputting or otherwise providing a uniform resource locator (URL) or other network address associated with the repair assistance application 108 to a client application. In this regard, in one or more implementations, the client application 104 may be utilized to access or otherwise initiate an instance of the repair assistance application 108, where the repair assistance application 108 provides one or more web page GUI displays within the client application 104 that include GUI elements and other graphical indicia facilitating resolution of a potential fault condition associated with a vehicle, as described in greater detail below.

In exemplary implementations, the remote system 110 includes a host server 112, which generally represents a central server, a remote server, a cloud computing system or any other sort of remote processing system or computing device capable of communicating over the network 106. In this regard, the remote processing system includes a processing system 114, which could be realized using any sort of processor, controller, central processing unit, graphics processing unit, microprocessor, microcontroller and/or a combination thereof that is suitably configured to support the subject matter described herein. The host server 112 may also include or otherwise access a data storage element 116, which could be realized as any sort of memory (e.g., a random-access memory, a read-only memory, flash memory, etc.), data store (e.g., a solid-state drive, a hard disk drive, mass storage, etc.), database or any other short- or long-term storage media or other non-transitory computer-readable medium capable of storing or otherwise maintaining one or more artificial intelligence (AI) models 118 and/or other data along with computer-executable programming instructions for execution by the processing system 114 to generate instances of the repair assistance application 108 and support the various tasks, operations, functions and processes described herein.

In exemplary implementations, the repair assistance application 108 includes a component identification service 120 that is configured to identify or otherwise determine what electrical circuit, electronics module or other electrical component is associated with a detected fault condition based at least in part on an input diagnostic code received from the client device 102 over the network 106 and metadata characterizing the vehicle associated with the input diagnostic code. In this regard, the component identification service 120 maps or otherwise converts a combination of an input diagnostic code and associated vehicle metadata to a corresponding identification of the particular electrical circuitry, electrical wiring, electrical system (or subsystem), electronics module or other electrical component that the diagnostic code is likely attributable to. For purposes of explanation, the electrical circuitry, electrical wiring, electrical system, electronics module or electrical component that is identified as likely to be associated with the fault condition that triggered that diagnostic code may alternatively be referred to herein as the electrical circuit under test. In one implementation, the component identification service 120 leverages a netlist algorithm using design data 134, where the design data 134 is the abstract of the 3 dimensional computer-aided-design(CAD) data converted into structural data represented in a tabular format that represents the detailed build of the electrical harness as a bill of material, in order to obtain circuit data including information pertaining to the wire(s), the cable(s), the connector(s), the pin(s), the component(s) and/or the module(s) that belong to the electrical circuit under test. The component identification service 120 provides a corresponding netlist of the circuit data for the electrical circuit under test to a resolution prediction service 122 and/or a display service 124 of the repair assistance application 108 for further processing. The component identification service 120 leverages a combination of word or text matching between the main modules on the section of the harness and the diagnostic code description to determine the circuit where the area of the probable fault is present on the electrical system. In an exemplary implementation, the display service 124 utilizes the netlist of the circuit data for the electrical circuit under test to generate schematic, three-dimensional and/or immersive views of the respective components and modules to depict information pertaining to an area of interest or depict where a faulty module or connector exists on the vehicle.

The resolution prediction service 122 that is configured to receive the identification of the electrical circuit under test (or the circuit data netlist associated therewith) from the component identification service 120 and utilizes the electrical circuit under test and the associated vehicle metadata to calculate or otherwise predict the most likely or probable troubleshooting or repair actions for resolving the fault condition (alternatively referred to herein as probable resolution actions) using natural language processing (NLP), machine-learning, deep learning, robotics or other artificial intelligence (AI) techniques in concert with a prediction model 118. In this regard, in exemplary implementations, the remote system 110 includes or otherwise accesses one or more databases 130 or similar data storage that maintains a diagnostics log 132 of historical diagnostics data that maintains associations between previously-observed diagnostics codes, the electrical circuit under test associated with a respective diagnostic code, resolution data indicative of the one or more step(s) or action(s) that were performed to resolve the respective fault condition associated with the respective electrical circuit under test, and the associated vehicle metadata associated with the respective pairing of diagnostic code and resolution data.

In exemplary implementations, the prediction model 118 is developed or trained using the relationships between the respective historical sets of diagnostic code, electrical circuit under test and vehicle metadata input variables and the corresponding historical resolution data output variable to derive an equation or function for mapping an input diagnostic code and associated vehicle metadata input to output resolution data with a particular probability or likelihood. In other words, NLP, AI or other machine learning techniques are utilized to determine which combination of diagnostic code, electrical circuit under test and vehicle metadata is correlated to or predictive of a particular resolution action (or set of resolution actions) and determine a corresponding equation, function, or model for calculating the probability or likelihood that a given resolution action with respect to the input electrical circuit under test will resolve the input diagnostic code.

In one or more exemplary embodiments, the resolution prediction service 122 utilizes bidirectional encoder representations from transformers (BERT) machine learning techniques to derive the prediction model 118 from the historical diagnostics data maintained in the diagnostics log 132 and convert a subsequent combination of an input diagnostic code, an electrical circuit under test and associated vehicle metadata to listing of one or more probable resolution actions. The BERT model is bidirectionally trained to provide a deeper sense of language context and flow than single-direction language models using a transformer, an attention mechanism that learns contextual relations between words (or sub-words) in a text. An encoder of the transformer reads a text input and a decoder of the transformer produces a prediction, where the transformer encoder reads the entire sequence of words at once (or bidirectionally) to learn the context of a word based on all of its surroundings (left and right of the word). The BERT model is trained using a masked language modeling (MLM) technique, where before feeding word sequences into the BERT model, some percentage of the words (e.g., 15%) in each sequence are replaced with a mask token. The BERT model then attempts to predict the original value of the masked words, based on the context provided by the other, non-masked, words in the sequence. This process is calculating the probability of each word in the vocabulary. Along with the building the probability of each word occurrence, BERT model is trained for next sentence prediction (NSP), where the model receives pairs of sentences as input and learns to predict if the second sentence in the pair is the subsequent sentence in the original document. During training, fifty percent of the inputs are a pair in which the second sentence is a subsequent sentence in the original sequence, while in the other fifty percent a random sentence from the corpus is chosen as a second sentence. The assumption is that the random sentence will be disconnected from the first sentence. The BERT model along with the MLM and NSP are trained together, with the goal of minimizing a combined loss function of the two strategies using a corpus or training data set consisting of historical diagnostics data from historical resolutions that were captured over a preceding period of time (e.g., historical diagnostics data from the diagnostics log 132). In this manner, the prediction model 118 that is based on BERT NLP is trained to predict electrical defects and corresponding resolutions. It should be noted that the subject matter described herein is not limited to BERT, and may be implemented using other NLP techniques, such as, for example, generative pre-trained transformer (GPT) techniques or the like. Moreover, the resolution prediction service 122 and the prediction model are not limited to electrical systems or electrical defects and can be implemented in an equivalent manner to predict resolution actions for non-electrical defects, such as paint defects, general assembly defects and quality defects.

Still referring to FIG. 1, in exemplary implementations, the repair assistance application 108 also includes a diagnostic display service 124 that is configured to receive indicia of the probable resolution actions output by the resolution prediction service 122 and generate corresponding GUI displays within the client application 104 at the client device 102 that include graphical indication of a probable (or recommended) resolution action and one or more graphical representations of the electrical circuit under test to facilitate the depicted resolution action. As described in greater detail below, in one or more implementations, the diagnostic display service 124 utilizes the indicia of the probable resolution actions to sequentially provide step-by-step guidance through potential resolution actions in accordance with the calculated probability or likelihood assigned to a respective resolution action by the resolution prediction service 122 using the prediction model 118. In concert with providing graphical indicia of the resolution action(s), exemplary implementations of the diagnostic display service 124 also utilizes computer-aided design (CAD) data 134 associated with the particular electrical circuit under test and/or the vehicle metadata to provide graphical representations of the electrical circuit(s) associated with the electrical circuit under test, graphical representations of the physical location of the electrical circuit under test in relation to the vehicle, and/or the like, as described in greater detail below. In this regard, the design data 134 may be stored or otherwise in a database 130 or other data storage associated with the remote system 110.

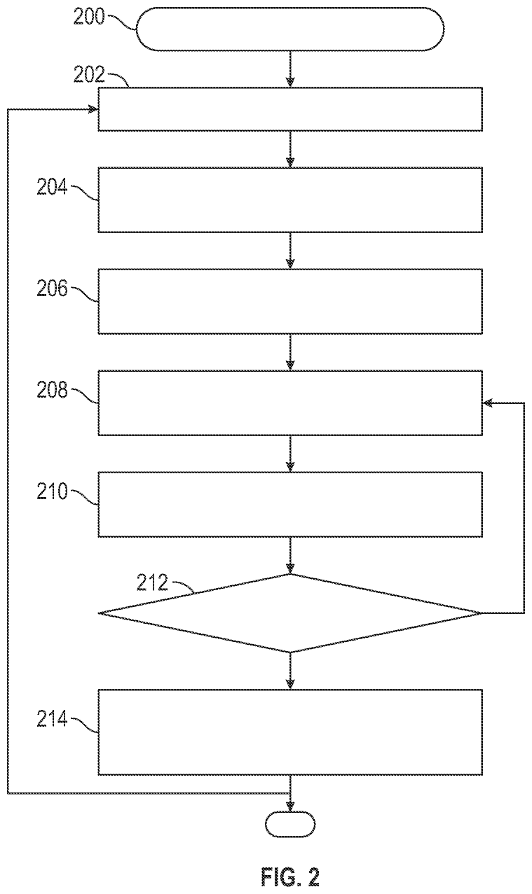

FIG. 2 depicts an exemplary implementation of a predictive resolution guidance process 200 suitable for implementation in the context of a vehicle diagnostics system 100 to support self-guided troubleshooting by a user performing potential resolution actions in a step-by-step manner in accordance with the predicted probability the potential resolution actions will solve the fault condition. For illustrative purposes, the following description may refer to elements mentioned above in connection with FIG. 1. While portions of the predictive resolution guidance process 200 may be performed by different elements of a vehicle diagnostics system, for purposes of explanation, the subject matter may be primarily described herein in the context of the predictive resolution guidance process 200 being primarily performed by an instance of the repair assistance application 108 that is accessed over a communications network 106.

In exemplary implementations, the predictive resolution guidance process 200 begins by receiving or otherwise obtaining metadata associated with a vehicle exhibiting a potential fault condition at 202 and a diagnostic code associated with the vehicle at 204. For example, a user may utilize a web browser or other client application 104 at the client device 102 to access an instance of the repair assistance application 108 over the network 106, with the repair assistance application 108 generating or otherwise providing a GUI display associated with the repair assistance application 108 within the client application 104 at the client device 102 that includes one or more GUI elements that allow the user to input or otherwise provide metadata associated with the vehicle including, for example, a vehicle identification number (VIN), a primary vehicle identifier (PVI) or other vehicle identifier along with other information or data characterizing the vehicle under test, such as, for example, a model name associated with the vehicle, a year or date of manufacture associated with the vehicle and/or the like. In some implementations, the repair assistance application 108 utilizes the vehicle metadata to query or otherwise retrieve the diagnostic code(s) (e.g., a diagnostics trouble code (DTC), a middleware testing tool (MTT) code, or the like) associated with the vehicle from a diagnostics log 132 or other device or location on the network 106. That said, in other implementations, the repair assistance application 108 provides one or more GUI elements on a GUI display associated with the repair assistance application 108 that allow the user to input or otherwise provide a diagnostic code associated with a detected fault condition for the vehicle under test.

At 206, the predictive resolution guidance process 200 identifies or otherwise determines the electrical circuit associated with the fault condition based at least in part on the diagnostic code and the vehicle metadata. As described above, the component identification service 120 maps or otherwise converts the combination of the diagnostic code and associated vehicle metadata to a corresponding identification of the particular electrical circuitry, electrical wiring, electrical system (or subsystem), electronics module or other electrical component that the diagnostic code is likely attributable to. In one implementation, the component identification service 120 utilizes the vehicle metadata to retrieve or otherwise obtain computer-aided design (CAD) data 134 for the electrical systems associated with the vehicle from a database 130 and utilizes a cosine similarity algorithm to match the description associated with the diagnostics code to electrical circuitry, electrical wiring, electrical system (or subsystem), electronics module or another electrical component of the vehicle that matches the diagnostics code description, and then identifies the electrical circuit under test as the particular electrical circuit associated with the vehicle that includes that matching electrical component.

After identifying the electrical circuit under test that the diagnostic code is likely attributable to, the predictive resolution guidance process 200 calculates or otherwise determines one or more probable resolution actions that are likely to resolve the underlying fault condition triggering the diagnostic code at 208. As described above, the resolution prediction service 122 utilizes a prediction model 118 derived from historical diagnostics data maintained in a diagnostics log 132 to calculate or otherwise a probability or likelihood of a troubleshooting or repair action resolving the diagnostic code based on historical correlations between the diagnostic code, the electrical circuit under test and the associated vehicle metadata and the actions that were previously successful at resolving the diagnostic code in the past. For example, the resolution prediction service 122 may utilize one or more of the diagnostic code, the electrical circuit under test and the associated vehicle metadata to query the diagnostic log(s) 132 to identify troubleshooting or repair actions that were previously successful at resolving the fault condition for that diagnostic code and/or electrical circuit under test for similar vehicles, and then utilize the prediction model 118 and NLP techniques to calculate or otherwise determine a probability of a respective troubleshooting or repair action resolving the fault condition based on the historical diagnostics data. In one implementation, the resolution prediction service 122 is configured to output or otherwise provide an ordered listing of potential troubleshooting or repair actions that are likely to resolve the fault condition according to the respective probabilities of resolution associated with each respective troubleshooting or repair action in the listing.

Still referring to FIG. 2, the predictive resolution guidance process 200 continues by providing graphical indicia of probable troubleshooting or repair actions in accordance with their respective probabilities or likelihood of the respective action resolving the fault condition at 210 until the fault condition is resolved at 212. In this regard, the display service 124 of the repair assistance application 108 sequentially presents guidance pertaining to a particular troubleshooting or repair action to guide the user through the probable resolution actions in a step-by-step manner until the fault condition associated with the diagnostic code is resolved, as described in greater detail below. After resolving the fault condition, the repair assistance application 108 updates the diagnostics log 132 to store or otherwise maintain indication of the troubleshooting or repair action that successfully resolved the fault condition in association with the diagnostic code, the associated vehicle metadata and the electrical circuit under test. In exemplary implementations, the predictive resolution guidance process 200 updates the prediction model to reflect the particular troubleshooting or repair action that successfully resolved the fault condition at 214. In this regard, the prediction model 118 may be dynamically updated over time to adapt to the diagnostics data maintained in the diagnostics log 132 to improve the guidance provided to users when troubleshooting subsequent fault conditions.

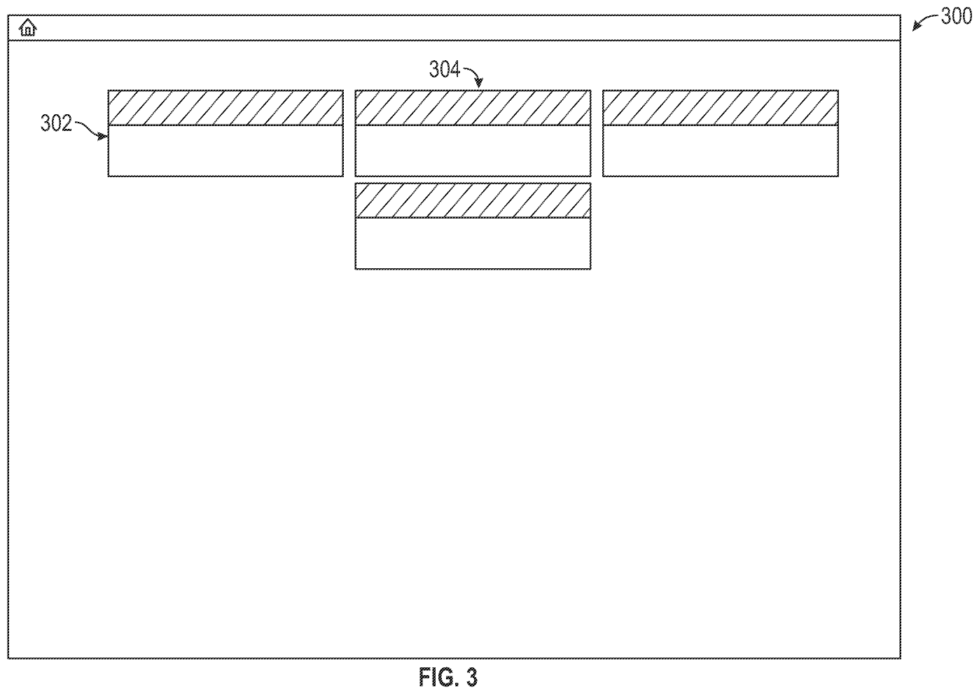

FIGS. 3-11 depict an exemplary sequence of GUI displays that may be presented by a repair assistance application 108 within a client application 104 at a client device 102 in connection with one or more implementations of the predictive resolution guidance process 200 of FIG. 2. In this regard, FIG. 3 depicts an exemplary landing page GUI display 300 that may be generated by the repair assistance application 108 when a user of the client device 102 interacts with the client application 104 to access or otherwise navigate to a URL or other network address associated with the repair assistance application 108. In the illustrated example, the landing page GUI display 300 includes a first selectable GUI element 302, such as a card, a button, a hyperlink, or another GUI element that is selectable by the user to access or otherwise navigate to a repair overview GUI display 400 that may be generated by the repair assistance application 108 based on a diagnostics log 132.

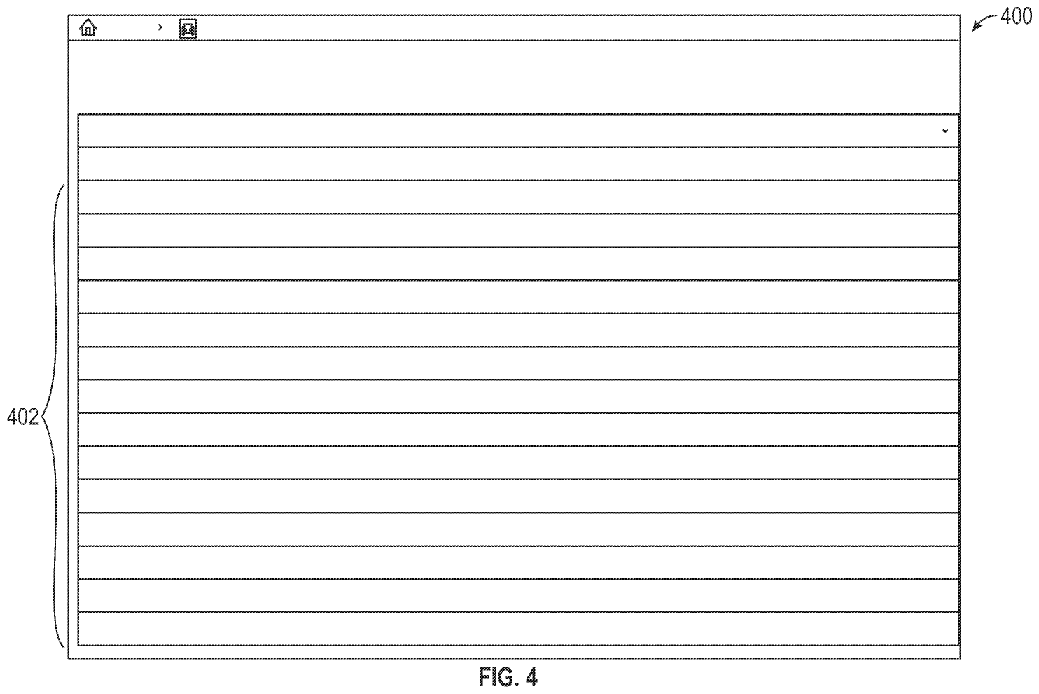

Referring to FIG. 4, the repair overview GUI display 400 includes a listing 402 of vehicles exhibiting potential fault conditions and having one or more diagnostic codes associated therewith that have not yet been resolved (e.g., based on entries in a diagnostics log 132 that have one or more diagnostic codes associated therewith but do not have a resolution action associated therewith). In exemplary embodiments, the listing 402 of vehicles is rendered using hyperlinks or other selectable GUI elements corresponding to the respective vehicles that allow a user to initiate the predictive resolution guidance process 200 by selecting an individual vehicle from the listing, thereby providing or otherwise indicating indicate the vehicle metadata (e.g., at 202) to be utilized. Selection of an individual vehicle from the listing 402 results in the repair assistance application 108 generating a vehicle search GUI display 500 using the identification information associated with the selected vehicle to search for associated diagnostic codes for analysis in the diagnostics log 132.

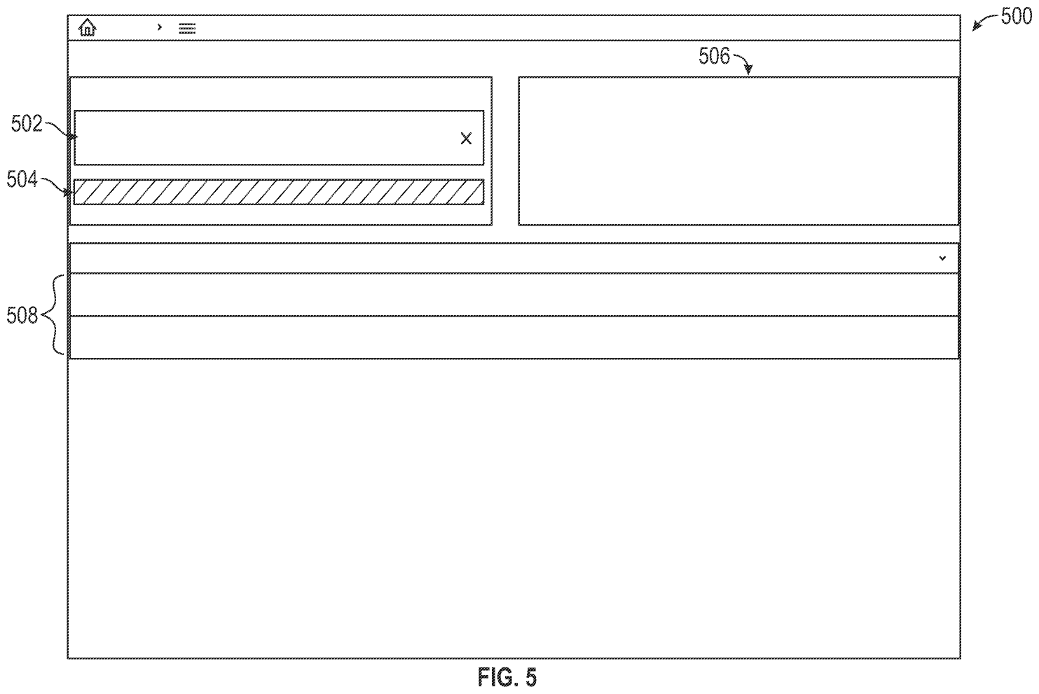

Referring again to FIG. 3 with reference to FIG. 5, the landing page GUI display 300 includes a second selectable GUI element 304, such as a card, a button, a hyperlink, or another GUI element that is selectable by the user to access or otherwise navigate to the vehicle search GUI display 500, which includes a text box 502 or similar input GUI element that allows the user to input or otherwise provide indicia of a particular vehicle for which the user would like to analyze. In response to selection of a button 504 or similar GUI element, the repair assistance application 108 may query or otherwise search a diagnostics log 132 for a matching entry using the vehicle identification information input via the text box 502 as a search key. The repair assistance application 108 updates the vehicle search GUI display 500 to include a vehicle information region 506 containing graphical representations or other indicia of the metadata associated with the identified vehicle along with a diagnostics region 508 that includes a listing of the diagnostic codes associated with the identified vehicle.

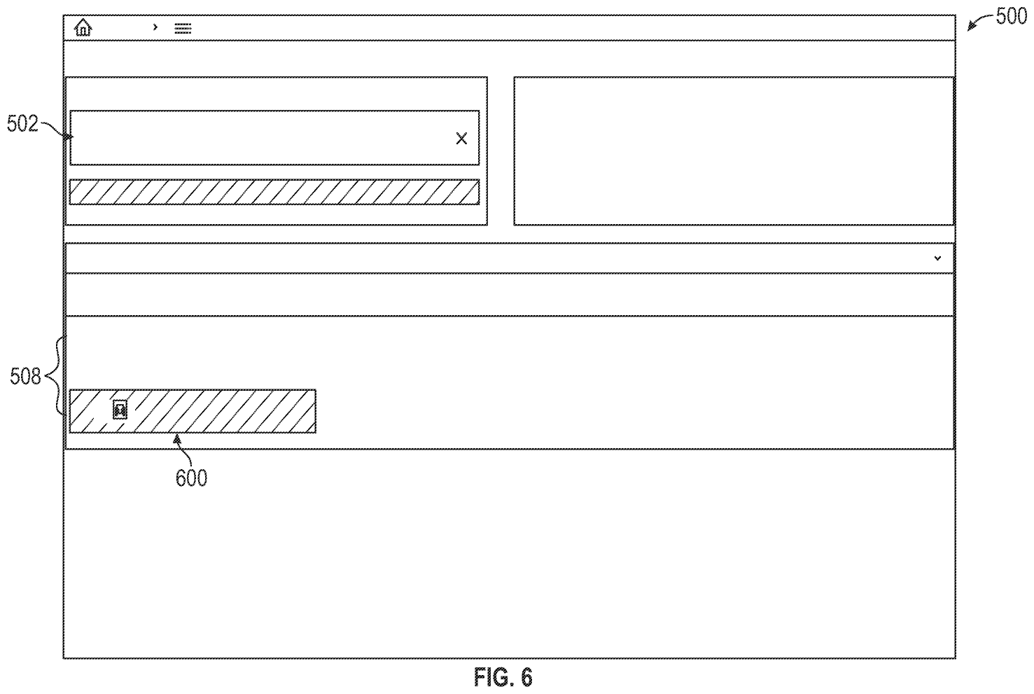

Referring now to FIG. 5 with reference to FIG. 6, in exemplary embodiments, the listing of diagnostic codes in the diagnostics region 508 is rendered using hyperlinks or other selectable GUI elements corresponding to the respective diagnostic codes that allow a user to initiate the predictive resolution guidance process 200 by selecting an individual diagnostic code from the listing, thereby providing or otherwise indicating the diagnostic code(s) (e.g., at 204) to be utilized by the predictive resolution guidance process 200 along with the previously-retrieved vehicle metadata (e.g., at 202) for the input vehicle identifier. In response to selection of an individual diagnostic code, the repair assistance application 108 updates the vehicle search GUI display 500 to depict additional information related to the selected diagnostic code along with a button 600 or similar GUI element that is selectable by the user to initiate the predictive resolution guidance process 200 with respect to the selected diagnostic code using the associated vehicle metadata.

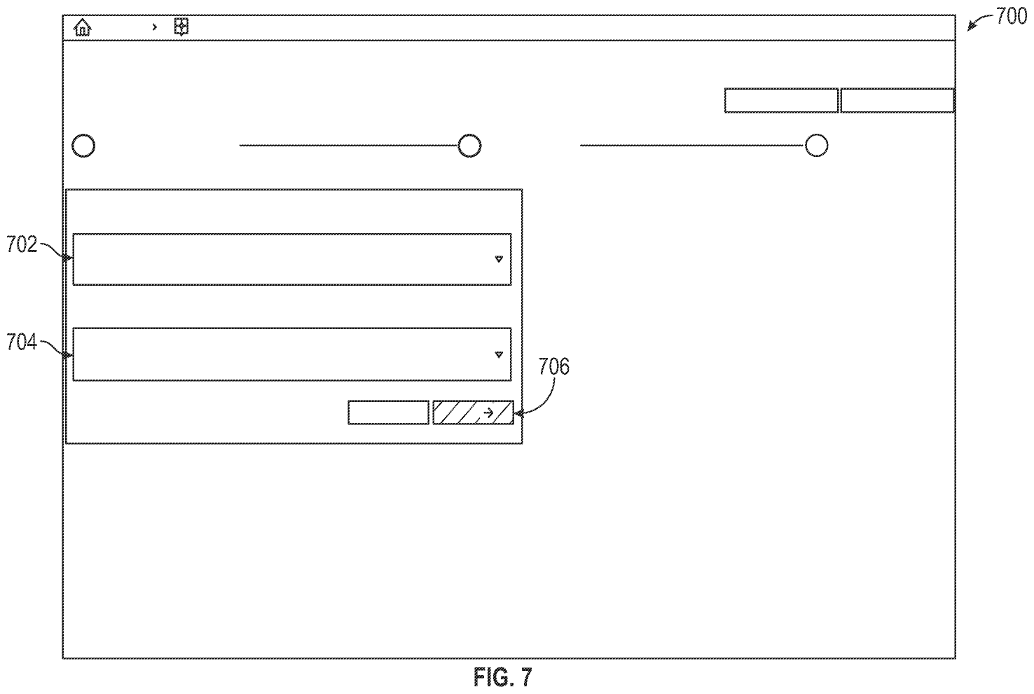

FIG. 7 depicts an exemplary repair assistance GUI display 700 that may be generated by the repair assistance application 108 in response to the user selecting or otherwise indicating the particular diagnostic code associated with a particular vehicle that the user would like to troubleshoot (e.g., in response to selection of the button 600). The repair assistance GUI display 700 includes a GUI element 702 that is populated with text that provides indication of the electrical circuit under test that was identified as being responsible for the selected diagnostic code given the associated vehicle metadata, as described above (e.g., at 206). For example, based on the make and model of the vehicle and the diagnostic code, the component identification service 120 may identify or otherwise determine that the right rear wheel speed sensor circuit is the electrical circuit that is likely to be associated with the fault condition. The illustrated embodiment of the repair assistance GUI display 700 includes another GUI element 704 that is manipulable by the user to select or otherwise indicate a desire to initiate diagnostics with respect to the identified electrical circuit under test and a button 706 or similar selectable GUI element that allows the user to initiate step-by-step troubleshooting guidance of the identified electrical circuit under test to sequentially advance through the troubleshooting or repair actions that are most likely to resolve the diagnostic code given the associated vehicle metadata (e.g., at 208 and 210 of the predictive resolution guidance process 200).

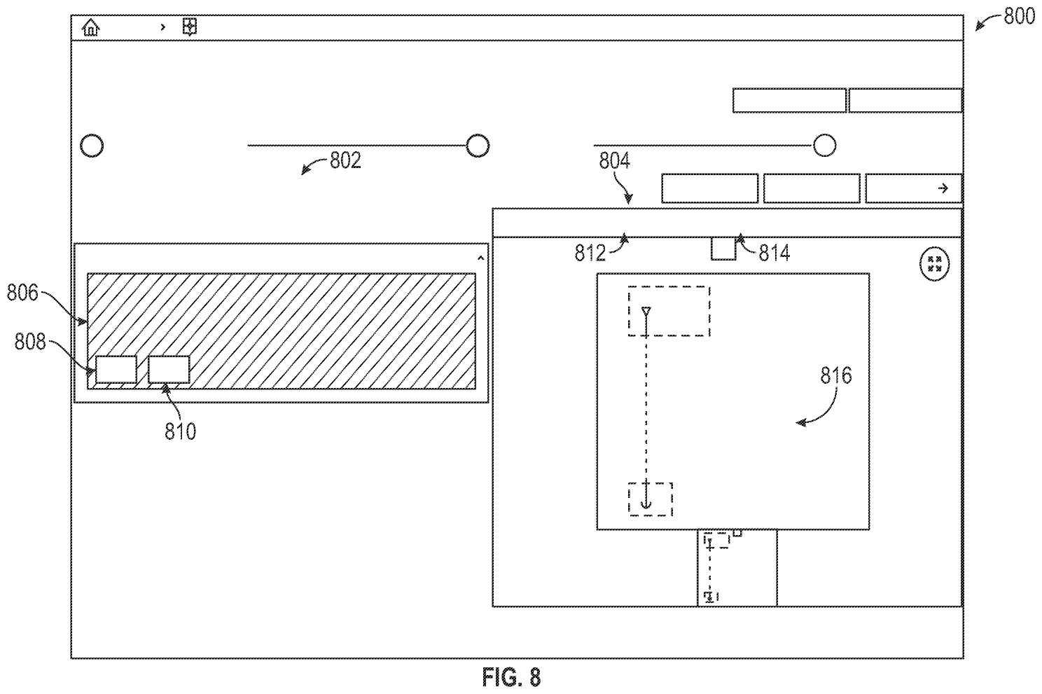

Referring to FIGS. 8-10, in response to selection of the button 706 to initiate diagnostics of the selected diagnostic code and identified electrical circuit, the repair assistance application 108 sequentially generates troubleshooting GUI displays 800, 900, 1000 as the user sequentially progresses through troubleshooting actions that are most likely to resolve the diagnostic code in accordance with their predicted or estimated probability of success determined by the resolution prediction service 122 using the prediction model 118. The troubleshooting GUI displays 800, 900, 1000 include a step-by-step guidance region 802 for providing textual information pertaining to the troubleshooting action expected to resolve the fault condition and an image region 804 for depicting imagery corresponding to the active troubleshooting action depicted in the step-by-step guidance region 802. In this regard, the initial state of the step-by-step guidance region 802 includes a graphical indication 806 with textual information identifying the troubleshooting action that was identified by the resolution prediction service 122 as most likely to resolve the fault condition (e.g., the action identified as having the highest probability based on the prediction model 118 at 208 of the predictive resolution guidance process 200) and providing guidance for how to perform the recommended troubleshooting action (e.g., at 210 of the predictive resolution guidance process 200). The graphical indication 806 may be realized using a card or similar container GUI element that includes explanatory textual information for the action along with buttons or similar GUI elements 808, 810 that the user may utilize to provide feedback for whether or not the action was successful at resolving the fault condition.

In concert with providing graphical indicia of a recommended troubleshooting action within the step-by-step guidance region 802, in exemplary implementations, the repair assistance application 108 (or the diagnostic display service 124) concurrently populates the image region 804 with an image or other graphical representation associated with the recommended troubleshooting action. For example, the image region 804 includes a graphical representation 816 of the electrical circuit under test or at least the portion of the electrical circuit under test relevant to the currently-active recommended troubleshooting action depicted in the step-by-step guidance region 802. In exemplary implementations, the image region 804 includes a first selectable GUI element 812 to initiate presentation of a schematic view of the electrical circuit under test and a second selectable GUI element 814 to initiate presentation of a three-dimensional CAD view of the electrical circuit under test. In this regard, FIG. 8 depicts a state where selection or activation of the schematic GUI element 812 causes the diagnostic display service 124 to display a graphical representation 816 of a circuit diagram of the wheel speed sensor circuit that depicts the supply voltage.

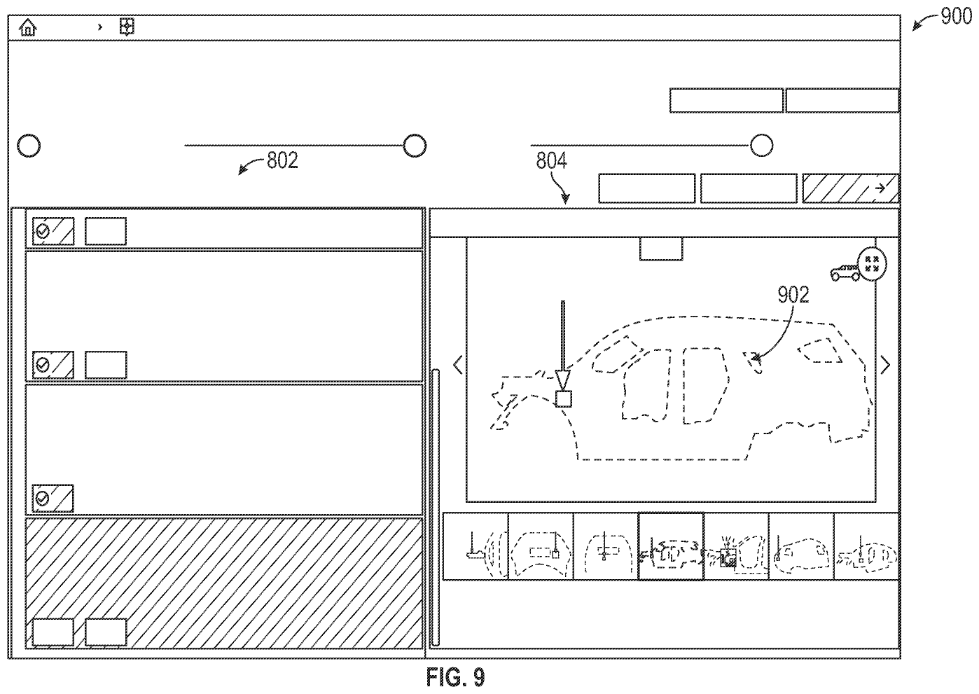

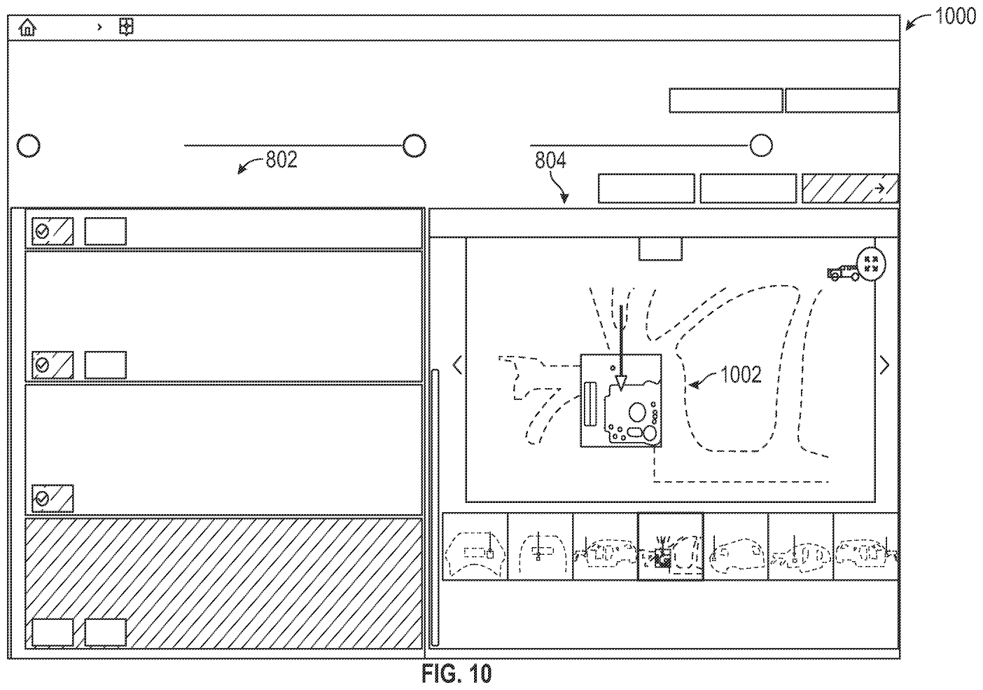

Referring to FIGS. 9-10, when the initially-recommended highest probability troubleshooting action is unsuccessful, the user selects the NO button 808 to cause the diagnostic display service 124 of the repair assistance application 108 to dynamically update one or more of the regions 802, 804 (e.g., at 212 of the predictive resolution guidance process 200) to sequentially progress through the recommended troubleshooting actions having the next highest probability based on the prediction model 118 at 208 of the predictive resolution guidance process 200. In this regard, FIG. 9 depicts an updated state of a troubleshooting GUI display 900 where the step-by-step guidance region 802 includes graphical representations of previously-attempted troubleshooting actions in a top-down sequential order, with the currently-active recommended troubleshooting action being depicted at the bottom of the step-by-step guidance region 802. In the example of FIG. 9, the 3D image GUI element 814 is selected or active, resulting in the diagnostic display service 124 utilizing the design data 134 associated with the identified electrical circuit under test and the current vehicle metadata to generate a three-dimensional graphical representation 902 of the component of the electrical circuit under test relevant to the currently-active recommended troubleshooting action. In this regard, the three-dimensional graphical representation 902 of the component may be rendered with respect to a three-dimensional graphical representation of the vehicle, thereby facilitating the user locating the component to perform the recommended troubleshooting action. In some implementations, the repair assistance application 108 (or the diagnostic display service 124) may dynamically update the content of the image region 804 in concert with dynamically updating the step-by-step guidance region 802 to maintain a lockstep relationship between the regions 802, 804 where the image region 804 depicts an image associated with the currently-active recommended troubleshooting action in the step-by-step guidance region 802.

FIG. 10 depicts an updated state of the troubleshooting GUI display 1000 where the user interacts with one or more GUI elements of the image region 804 to cause the diagnostic display service 124 to generate a different three-dimensional graphical representation 1002 of the relevant component of the electrical circuit under test. In this regard, the user may utilize the image region 804 of the troubleshooting GUI displays 800, 900, 1000 to retrieve and view different representations of the electrical circuit under test and the component(s) thereof that are relevant to the currently-active recommended troubleshooting action, thereby facilitating the user performing the currently-active recommended troubleshooting action without need to reference manuals or other external materials, and without requiring the user having pre-existing knowledge of the design or arrangement of the component(s) of the electrical circuit under test.

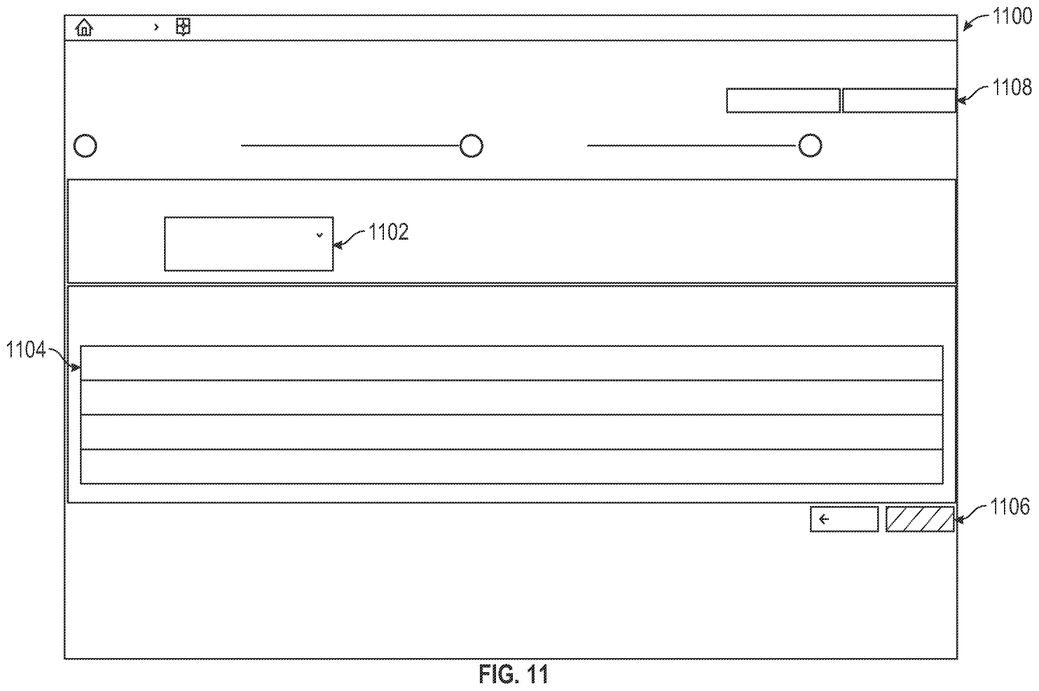

Referring now to FIG. 11, once the potential fault condition associated with the diagnostic code has been resolved, the user may select a GUI element on a troubleshooting GUI display 800, 900, 1000 to indicate that the currently-active recommended troubleshooting action successfully resolved the fault condition (e.g., YES button 810). In response, the repair assistance application 108 may generate a diagnostic feedback GUI display 1100 within the client application 104 at the client device 102 that allows the user to update the diagnostics log 132 to indicate that the particular diagnostic code associated with the selected vehicle has been successfully resolved. The diagnostic feedback GUI display 1100 includes a GUI element 1102 that a user may manipulate or otherwise interact with to provide indicia of a repair status to be associated with the diagnostic code along with a graphical representation 1104 of the sequence of troubleshooting actions that were performed. The user may select a button 1106 to submit the diagnostic data to the remote system 110 for updating the diagnostics log 132 to maintain the sequence of troubleshooting actions and the repair status in association with the particular diagnostic code and vehicle metadata. In this regard, the updated diagnostic data associated with the current repair may be utilized to adaptively update the prediction model 118 to improve the sequence of recommended troubleshooting actions during subsequent repairs to reduce the number of troubleshooting actions required to resolve the fault condition. Additionally, the diagnostic feedback GUI display 1100 includes a GUI element 1108 that may be selected by the user to input or otherwise provide additional feedback regarding the repair for maintenance in the diagnostics log 132. For example, the user may provide freeform text characterizing the troubleshooting actions or other aspects of the repair, which, in turn, may be analyzed at the remote system 110 (e.g., using NLP) to improve the performance of the component identification service 120, the resolution prediction service 122 and/or the prediction model 118.

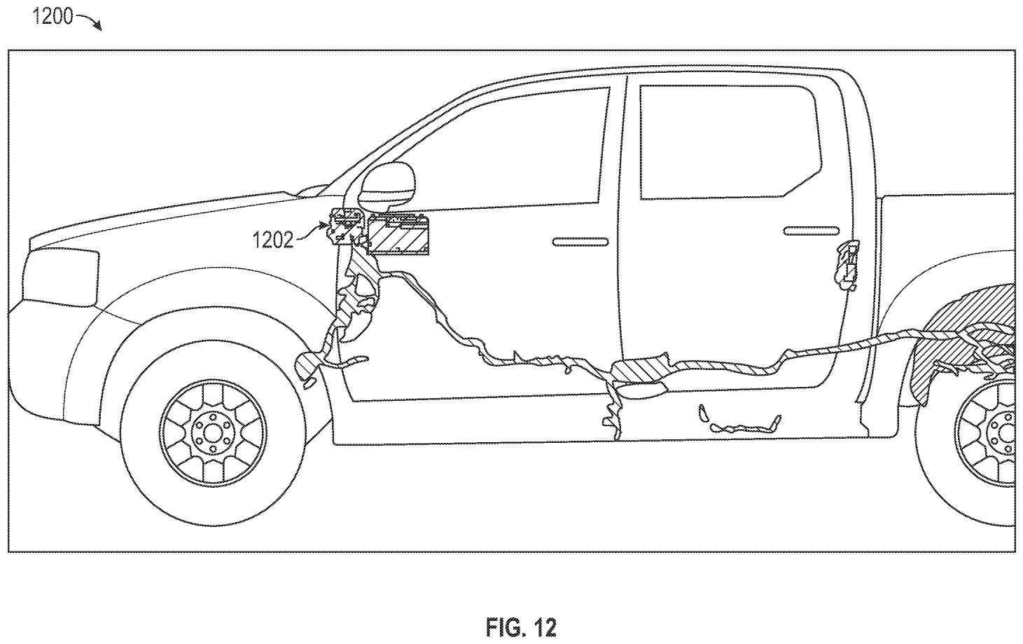

FIG. 12 depicts an exemplary immersive GUI display 1200 that may be presented by a repair assistance application 108 at a client device 102 in connection with one or more implementations of the predictive resolution guidance process 200 of FIG. 2. For example, in some implementations, the client device 102 may be realized as a head-mounted device or other device configured to support a heads-up display or an augmented reality display where the repair assistance application 108 provides graphical indicia 1202 of the component of the electrical circuit under test relevant to the currently-active recommended troubleshooting action overlying a vehicle in the real-world environment proximate the user or overlying a graphical representation of the vehicle. A user may select a GUI element associated with an image region of a troubleshooting GUI display to initiate presentation of the immersive GUI display 1200 and then orient or otherwise position the client device 102 to align with at least a portion of the vehicle that includes the component of the electrical circuit under test relevant to the currently-active recommended troubleshooting action. For example, the client device 102 may include a camera or another imaging or sensing device capable of detecting and determining the spatial relationship of the client device 102 with respect to the vehicle (e.g., using object detection, object recognition and/or other computer vision techniques), so that the graphical indicia 1202 of the location and arrangement of the component of the electrical circuit under test relevant to the currently-active recommended troubleshooting action is depicted at the appropriate location on the client device 102 relative to the real-world position of the vehicle and the corresponding field of view or orientation of the client device 102 with respect to the vehicle. Thus, in some embodiments, the graphical indicia 1202 may be effectively anchored to the vehicle and move in a corresponding manner when the client device 102 is moved to maintain the visual association with the location and arrangement of the component of the electrical circuit under test on the vehicle.

Referring to FIGS. 1-12, exemplary implementations of the repair assistance application 108 provide a mobile-based self-guided electrical repair assistant tool for manufacturing team members to resolve electrical defects with significant reduction in mean time to repair (MTTR) to help support electric first time quality (eFTQ) goals and improve direct run rate (DRR). In this regard, the repair assistance application 108 can guide a repair person or other user with limited training through troubleshooting steps that will enable them to repair a vehicle at the end of the line, for example, by providing actionable steps to address a potential fault condition in the electrical system, visual representations of wiring harnesses within the vehicle, schematic diagrams of the electrical system and/or the like within an easy to navigate user interface presented on a client device 102. Additionally, the use of NLP, AI and/or other machine learning techniques (e.g., by the component identification service 120, the resolution prediction service 122 and/or the prediction model 118) to dynamically learn how to troubleshoot potential fault conditions or diagnostic codes in any vehicle based on past historical resolutions and historical diagnostic data. This allows the repair assistance application 108 (and services 120, 122, 124 associated therewith) to be utilized for any vehicle make or model and can also be used for future vehicles while reducing the need for laborious creation of knowledge-based content or text-based repair guides or training technicians.

For example, in one implementation, the repair assistance application 108 may be utilized at the end of the line when validation of the wiring harnesses is performed at the vehicle charging station once the battery and software installed at the vehicle. The repair assistance application 108 may then allow a technician or other user to check for diagnostic codes that were recorded by the testing and software flashing tools run against the vehicle, identify the component or module where the possible problem associated with a particular diagnostic code could be, and provide the technician with sequentially recommended troubleshooting actions in accordance with the probability of a respective troubleshooting action resolving the fault condition (e.g., checking if a connector is connected properly, checking if the connector is seated correctly, checking if there is power to the module, etc.). The repair assistance application 108 (e.g., the diagnostic display service 124) also provide the technician with schematic diagrams and three-dimensional images based on the diagnostic code to help the technician locate the particular component or module onboard the vehicle and check for power failures or other electrical issues in connection with a recommended troubleshooting action. The repair assistance application 108 can be utilized in real-time on vehicles on the production line to resolve problems in a few minutes before a vehicle rolls off the production line, which eliminates the need for passive repairs and delivers more vehicles to customers on-time.

In contrast to knowledge-based solutions that may need to be revised periodically and/or manually, the repair assistance application 108 (or the services 120, 122 associated therewith) can dynamically learn the probable troubleshooting actions for resolving any sort of fault condition or diagnostic code for any sort of vehicles (including new or future vehicles) based on historical resolutions using NLP, AI or other machine-learning algorithms. Additionally, the prediction algorithms or models may be trained substantially in real-time to learn to identify any type of fault condition, thereby allowing the repair assistance application 108 to be utilized for newer vehicles earlier in the manufacturing cycle (e.g., prior to when manual knowledge-based approaches could be developed). The repair assistance application 108 can also be implemented in a multilingual manner that eliminates the time, resources and other costs required to create different repair manuals in multiple different languages. Moreover, the repair assistance application 108 is not limited to vehicles or electrical fault conditions or diagnostic codes, and may be implemented in an equivalent manner for mechanical fault conditions or mechanical diagnostic codes or any other type of fault condition or diagnostic code independent of any particular context or application.

While at least one exemplary aspect has been presented in the foregoing detailed description, it should be appreciated that a vast number of variations exist. It should also be appreciated that the exemplary aspect or exemplary aspects are only examples, and are not intended to limit the scope, applicability, or configuration of the disclosure in any way. Rather, the foregoing detailed description will provide those skilled in the art with a convenient road map for implementing the exemplary aspect or exemplary aspects. It should be understood that various changes can be made in the function and arrangement of elements without departing from the scope of the disclosure as set forth in the appended claims and the legal equivalents thereof.

What is claimed is:

1. A non-transitory computer-readable medium comprising executable instructions that, when executed by a processor, cause the processor to:
obtain metadata associated with a vehicle;
obtain a diagnostic code associated with the vehicle;
identify a vehicle component associated with the diagnostic code based at least in part on the metadata;
determine a recommended troubleshooting action for resolving a potential fault condition associated with the diagnostic code based at least in part on the vehicle component and the metadata associated with the vehicle using historical diagnostics data; and
provide, within a client application at a client device, a graphical indication of the recommended troubleshooting action.

2. The non-transitory computer-readable medium of claim 1, wherein the executable instructions cause the processor to provide, within the client application at the client application, an image associated with the recommended troubleshooting action, wherein the graphical indication of the recommended troubleshooting action and the image are displayed concurrently on a graphical user interface (GUI) display within the client application at the client device.

3. The non-transitory computer-readable medium of claim 2, wherein:
the vehicle component comprises an electrical circuit; and
the image comprises a graphical representation of a circuit diagram associated with the electrical circuit.

4. The non-transitory computer-readable medium of claim 2, wherein the image comprises a three-dimensional graphical representation of the vehicle component.

5. The non-transitory computer-readable medium of claim 1, wherein the executable instructions cause the processor to provide, within the client application at the client device, a graphical user interface (GUI) display including the graphical indication of the recommended troubleshooting action and a GUI element to receive indication of an outcome of the recommended troubleshooting action.

6. The non-transitory computer-readable medium of claim 5, wherein the executable instructions cause the processor to dynamically update the GUI display to include a second graphical indication of a second recommended troubleshooting action in response to selection of the GUI element to indicate the outcome of the recommended troubleshooting action was unsuccessful.

7. The non-transitory computer-readable medium of claim 6, wherein the executable instructions cause the processor to identify the second recommended troubleshooting action as one of a plurality of potential troubleshooting actions having a next highest probability of resolving the potential fault condition after the recommended troubleshooting action based on the prediction model.

8. The non-transitory computer-readable medium of claim 1, wherein the executable instructions cause the processor to determine the recommended troubleshooting action by identifying one of a plurality of potential troubleshooting actions having a highest probability of resolving the potential fault condition using a prediction model derived from the historical diagnostics data.

9. The non-transitory computer-readable medium of claim 8, wherein:
the prediction model is derived from the historical diagnostics data using bidirectional encoder representations from transformers (BERT); and
the executable instructions cause the processor to identify the one of the plurality of potential troubleshooting actions having the highest probability of resolving the potential fault condition using the prediction model and natural language processing (NLP) of at least one of the metadata associated with the vehicle, the diagnostic code associated with the vehicle, and the vehicle component associated with the diagnostic code.

10. The non-transitory computer-readable medium of claim 1, wherein the executable instructions cause the processor to provide one or more graphical user interface (GUI) displays within the client application at the client device, wherein the one or more GUI displays comprise one or more GUI elements for receiving user input comprising at least one of the metadata and the diagnostic code.

11. The non-transitory computer-readable medium of claim 1, wherein the executable instructions cause the processor to identify the diagnostic code associated with the metadata associated with the vehicle using the metadata associated with the vehicle in response to receiving user input comprising the metadata.

12. A method of facilitating diagnostics of a vehicle, the method comprising:
obtaining metadata associated with the vehicle;
identifying a diagnostic code associated with the vehicle using the metadata associated with the vehicle;
identifying a vehicle component associated with the diagnostic code based at least in part on the metadata;
determining a sequence of recommended troubleshooting actions for resolving a potential fault condition associated with the diagnostic code based at least in part on the vehicle component and the metadata associated with the vehicle using historical diagnostics data; and
sequentially providing, within a client application at a client device, graphical indicia of the recommended troubleshooting actions in accordance with the sequence based on a respective probability of resolution associated with a respective recommended troubleshooting action based at least in part on the historical diagnostics data.

13. The method of claim 12, further comprising providing, within the client application at the client device, one or more images associated with one or more of the recommended troubleshooting actions.

14. The method of claim 13, wherein providing the one or more images comprises providing a graphical representation of a circuit diagram associated with the vehicle component on a graphical user interface (GUI) display within the client application at the client device concurrent to providing a graphical indication of a recommended troubleshooting action of the one or more of the recommended troubleshooting actions on the GUI display.

15. The method of claim 13, wherein providing the one or more images comprises providing a three-dimensional graphical representation of the vehicle component on a graphical user interface (GUI) display within the client application at the client device concurrent to providing a graphical indication of a recommended troubleshooting action of the one or more of the recommended troubleshooting actions on the GUI display.

16. The method of claim 12, wherein sequentially providing the graphical indicia of the recommended troubleshooting actions comprises:
providing, on a graphical user interface (GUI) display within a client application at a client device, a graphical indication of an initial recommended troubleshooting action of the sequence having a highest probability of resolution associated therewith based at least in part on the historical diagnostics data; and
in response to user selection of a GUI element on the GUI display to indicate the initial recommended troubleshooting action was unsuccessful, dynamically updating the GUI display to provide a second graphical indication of a second recommended troubleshooting action of the sequence having a second highest probability of resolution associated therewith based at least in part on the historical diagnostics data.

17. The method of claim 16, further comprising:
providing, on the GUI display, a first image associated with the initial recommended troubleshooting action; and
dynamically updating the GUI display to provide a second image associated with the second recommended troubleshooting action in lieu of the first image in response to the user selection of the GUI element.

18. A system comprising:
a data storage element to maintain a log of diagnostics data; and
a server coupled to the data storage element and a network, the server comprising at least one processor and at least one non-transitory computer-readable medium comprising executable instructions that, when executed by the at least one processor, cause the at least one processor to provide a repair assistance application configurable to:
obtain, from a client device coupled to the network, metadata associated with a vehicle;
obtain, from the log of diagnostics data, a diagnostic code associated with the vehicle using the metadata;
identify a vehicle component associated with the diagnostic code based at least in part on the metadata;
determine a recommended troubleshooting action for resolving a potential fault condition associated with the diagnostic code based at least in part on the vehicle component and the metadata associated with the vehicle using a prediction model derived from at least a portion of the log of diagnostics data; and
provide, at the client device, a graphical indication of the recommended troubleshooting action.

19. The system of claim 18, wherein:
the data storage element maintains design data associated with the vehicle; and
the executable instructions cause the at least one processor to provide, within a client application at the client device, an image associated with the recommended troubleshooting action concurrently with providing the graphical indication of the recommended troubleshooting action.

20. The system of claim 19, wherein the image comprises a circuit diagram of the vehicle component or a three-dimensional graphical representation of the vehicle component.
